(19) United States
(12) Patent Application Publication
(10) Pub. No.: US 2003/0227226 A1
(43) Pub. Date: Dec. 11, 2003

(54) Rotary shaft motor

(76) Inventors: Masaki Goto, Nagano (JP); Yoshimi Takasu, Nagano (JP); Hisaya Nakagawa, Nagano (JP); Yasushi Mizusaki, Nagano (JP); Akitoshi Iizawa, Nagano (JP)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/386,773

(22) Filed: Mar. 12, 2003

(30) Foreign Application Priority Data
Mar. 13, 2002 (JP) 2002-069182

(51) Int. Cl. H02K 5/16

(52) U.S. Cl. 310/90

(57) ABSTRACT

A motor comprises a cylindrical hollow rotary shaft and a rotor member which is fitted over an outer circumference of an axial end of the rotary shaft fixed by a tight fit. A bottom portion is integrally provided to the axial end portion of the rotary shaft, to which the rotor member is fixed, to close an opening at the end portion. The bottom portion has a through hole to interconnect a space inside the rotary shaft with a space outside.

### CROSS REFERENCE TO RELATED APPLICATION

This application claims priority of Japanese Application No. 2002-069182, Filed on Mar. 13, 2002, the complete disclosure of which is hereby incorporated by reference.

### BACKGROUND OF THE INVENTION

a) Field of the Invention

The present invention relates to a motor having a rotary shaft which is formed to be cylindrical and hollow in shape.

b) Description of the Related Art

In general, a rotary shaft of a motor is rotatably supported by an appropriate bearing member which is provided at a stator portion, and the entire rotor portion is rotated together with the rotary shaft. In such a motor configured as above, the rotary shaft may be composed of a cylindrical hollow member having both end portions open.

By composing the rotary shaft of this kind of a cylindrical hollow member, the rotary shaft can be made light in weight so that a motor which rotates at high speed can be obtained inexpensively, and the heat-release of the rotary shaft is improved to increase the precision of rotation so that the life expectancy of the rotor can be increased.

Problems Addressed by the Invention

However, when a rotor member is fixed to the rotary shaft, which is composed of the above-mentioned cylindrical hollow member, by a tight fit such as press fit or shrink fit, the hollow rotary shaft is compressed in the radial direction by a compressive stress applied to the portion that is tight-fitted. This may degrade the circularity of the rotary shaft. If the circularity of the rotary shaft is degraded, a backlash may occur in the bearing member which in turn increases vibrations, possibly deteriorating the bearing property.

Particularly in a dynamic pressure motor using a hydrodynamic bearing member which uses a dynamic pressure of a lubricant fluid, as the circularity of the rotary shaft degrades, the clearance between the hydrodynamic bearing member and the rotary shaft becomes bigger. As a result, the dynamic pressure for supporting the rotary shaft tends to decrease, easily causing damage to the shaft by the metallic contacts. This may deteriorate the reliability of a bearing function.

### OBJECT AND SUMMARY OF THE INVENTION

Then, a primary object of the present invention is to provide a motor having a simple and inexpensive configuration, in which a cylindrical hollow rotary shaft can be supported excellently.

To achieve the above object, in accordance with the invention, a motor has a cylindrical hollow rotary shaft and a rotor member that is fitted over an outer circumference of an axial end of the rotary shaft fixed by a tight fit. The motor includes a bottom portion which is integrally provided to the axial end portion of the rotary shaft to close an opening at the end portion. A through hole is formed in the bottom portion to interconnect a space inside the rotary shaft with a space outside.

According to the motor described above, the rigidity of the axial end portion of the rotary shaft, i.e., the portion to which the rotor member is fixed, is greatly increased by the bottom portion. Therefore, the circularity of the cylindrical hollow rotary shaft can be excellently maintained against the compressive stress applied to the shaft when the rotor member is tight-fitted.

Also, various particles which are generated in the hollow inside of the rotary shaft when the rotary shaft is manufactured are easily discharged to the outside through the though hole in the bottom portion. Thus, the cleanliness of the rotary shaft can be easily and excellently maintained.

Further in accordance with the invention, the rotary shaft is supported by a hydrodynamic bearing member that uses a dynamic pressure of a lubricant fluid. Therefore, the bearing property of the dynamic pressure motor that particularly uses a hydrodynamic bearing member can be excellently maintained.

Still further, according to the motor of the invention, a fixing mechanism is fixed to the through hole to mount an appropriate rotary body to the rotary shaft. Consequently the rotary member can be easily and securely mounted by using the through hole.

Moreover, according to the motor of the invention, the cylindrical hollow rotary shaft having the bottom described is formed by drawing. Therefore, the rotary shaft can be efficiently manufactured.

### BRIEF DESCRIPTION OF THE DRAWING

In the drawing:

FIG. 1 is a vertical cross-sectional diagram showing an embodiment of a polygonal mirror driving motor of an optical deflecting device of the present invention.

### DESCRIPTION OF THE PREFERRED EMBODIMENTS

An embodiment of the present invention is described in detail hereinafter based on the drawing. Prior to the description, an example of a configuration of a polygonal mirror driving motor in an optical deflecting device, to which the present invention is applied, is described.

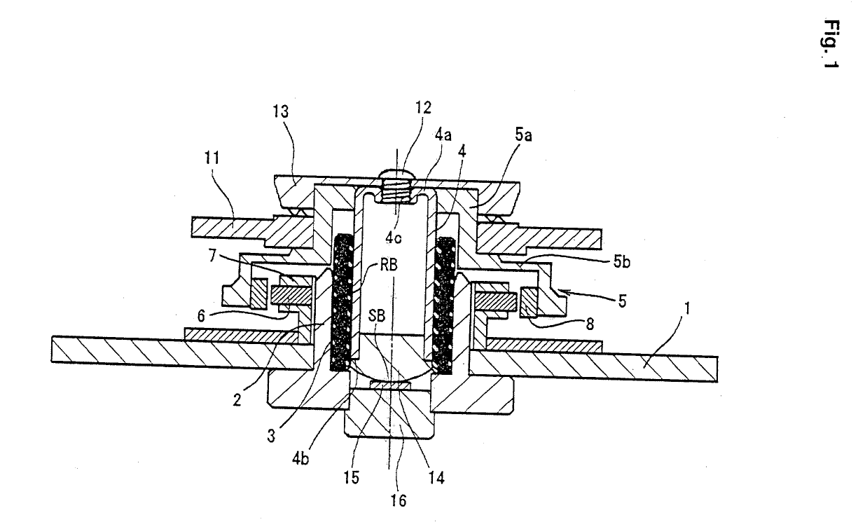

As illustrated in FIG. 1, a cylindrical hollow bearing holder 2 is fixed upright in the center portion of a motor substrate 1 which is a printed board. A bearing sleeve 3 serves as a hydrodynamic bearing member that uses a dynamic pressure of a lubricant fluid and is joined to an inner circumferential wall surface of the bearing holder 2 by a tight fit such as a press fit or a shrink fit. The bearing sleeve 3 is formed by a cylindrical hollow member which is composed of a material with copper such as a phosphor bronze to facilitate the machining of a hole having a small diameter. The cylindrical hollow rotary shaft 4 that constitutes a rotor portion is rotatably inserted into a center hole formed through the bearing sleeve 3. A detail of the configuration of the rotary shaft 4 will be described later.

A dynamic pressure surface on the inner circumferential wall portion of the bearing sleeve 3 is arranged to be opposite in the radial direction via a small gap from a dynamic pressure surface on the outer circumferential wall portion of the rotary shaft 4, and in the small gap, a radial dynamic pressure bearing portion RB is created In other words, the dynamic pressure surface of the radial hydrodynamic bearing portion RB on the bearing sleeve 3 side is arranged circumferentially to be opposite from the dynamic pressure surface on the rotary shaft 4 side via a small gap of several μm; and air is sued as a lubricant fluid and is filled in the bearing space of the very small gap in this embodiment.

Radial dynamic pressure generating grooves of a proper groove shape are cut annularly in parallel on at least one of the dynamic pressure surfaces of the bearing sleeve 3 and the rotary shaft 4, so that during the rotation the air is pressurized by a pumping action of the radial dynamic pressure generating grooves to generate a dynamic pressure. By the dynamic pressure, a rotor case 5 (to be described later) together with the rotary shaft 4 is supported in the radial direction in a non-contact manner with respect to the bearing sleeve 3.

At the portion at which the bearing holder 2 projects from the bearing sleeve 3 toward the top portion of the FIGURE, a stator core 6 composed of a laminated electromagnetic steel plate is fitted in the axial direction to the mounting surface on the outer circumference of the bearing holder 2; in the stator core 3, a coil wire 7 is wound around each of a plurality of salient-poles which project outwardly in the radial direction.

Further, a boss portion 5a of the rotor case 5, formed from an aluminum alloy, is fixed to an output portion of the rotary shaft 4, at which the rotary shaft 4 projects from the bearing sleeve 3 to the top portion of the FIGURE, by a tight fit such as a press fit or a shrink fit. Also, a rotor case main body 5b formed in a dish-like shape is integrally formed at the bottom side edge portion of the boss portion 5a to project outwardly in the radial direction. An annular rotor magnet 8 is attached to the inner circumferential surface of a flange-like upright wall which is formed at the outer circumferential portion of the rotor case main body 5b The inner circumferential surface of the rotor magnet 8 is arranged to be closely opposite in the radial direction from the outer end surface of each salient-pole of the stator core 6.

Also, a polygonal mirror 111 is placed in the axial direction over the outer circumferential surface of the boss portion Sa of the rotor case 5 to perform a deflection scanning of optical data. The polygonal mirror 11 is pressed down on to the top surface (in the FIGURE) of the rotary shaft 4 by a disk-like pressing member 13 which is attached via a fixing screw used as a fixing mechanism, and thus, sandwiched and fixed between the pressing member 13 and the rotor case main body 5b in the axial direction.

The above-mentioned rotary shaft 4 is composed of a stainless steel cylindrical hollow member having a bottom portion: the bottom portion 4a is integrally joined to an axial end portion (the top portion of the FIGURE) of the shaft to close an opening at the end portion; an opening 4b is formed at the other axial end portion (the bottom end portion of the FIGURE).

The rotary shaft 4 in such an embodiment like this is manufacture by drawing a flat plate of austenitic stainless steel material, for example, in several steps and the outer circumferential surface thereof is finished by a centerless polishing. It is also preferred that a surface treatment by a shot peening is given to the outer circumferential surface of the rotary shaft 4 to improve smoothness and abrasive durability.

Also, a through hole 4c is formed in the bottom portion 4a of the rotary shaft 4 by burring to interconnect the space inside the rotary shaft 4 with the space outside. A thread is formed by tap machining on the inner circumference of the through hole 4c. The fixing screw 12 used for mounting the above-mentioned pressing member 13 is screwed into the through hole 4c.

Furthermore, a sealing cap member 14 is fitted to the opening 4b formed at the bottom end (in the FIGURE) of the rotary shaft 4 to close the opening 4b. The sealing cap member 14 is formed with a hemispherical surface which projects from the opening 4b of the rotary shaft 4 toward the bottom portion of the FIGURE. The projecting point of the hemispherical surface is made to have contact with a disk-like thrust plate 15 to configure a pivotal thrust bearing portion SB. The thrust plate 15 is placed on a thrust supporting holder 16 which is screwed to close the opening of the bearing holder 2 at the bottom as in the figure.

According to the motor of this embodiment, the rigidity of the axial top portion of the rotary shaft 4, i.e., the rigidity of the portion of the rotary shaft 4 to which the rotor case 5 as a rotor member is fixed, is greatly increased by the bottom portion 4a. Therefore, against the compressive stress that is applied to the cylindrical hollow rotary shaft 4 having the bottom portion 4a when the rotor case 5 is fixed to the shaft by a tight fit, the circularity of the rotary shaft 4 can be excellently maintained.

Also, various particles Such as polishing particles, washing liquid, or other kinds of dust which may be generated during the manufacturing of the rotary shaft 4 can be easily discharged to the outside through the through hole 4c provided in the bottom portion 4a. Consequently the cleanliness of the rotary shaft 4 can be easily and excellently obtained.

Particularly in the embodiment, the present invention is applied to a dynamic pressure motor which uses a hydrodynamic bearing device using a dynamic pressure generated by using air as a lubricant fluid. Therefore, the bearing property of the dynamic pressure motor can be excellently maintained.

Further, in this embodiment, the fixing screw 12, which fixes the rotor case 5 to the rotary shaft 4, is screwed into the through hole 4c provided in the bottom portion 4a of the rotary shaft 4. Consequently the rotor case 5 can be easily and firmly mounted using the through hole 4c.

Furthermore, since the cylindrical hollow rotary shaft 4 having the bottom portion 4a is formed by drawing, the rotary shaft 4 can be manufactured efficiently.

Although the invention by the present inventors has been described based on the embodiment, the present invention is not limited to the above. It is needless to say that the present invention can be varyingly modified within the scope of the invention.

Although in the above embodiment the present invention is applied to a polygonal mirror driving motor, it can be applied to other kinds of motors and to even the motors that do not use a hydrodynamic bearing device.

As described above, the present invention provides a motor wherein a bottom portion is integrally provided to an axial end of a cylindrical hollow rotary shaft, to which a rotor member is fixed, to increase the rigidity of the portion of the rotary shaft at which the rotor member is fixed, so that the circularity of the rotary shaft can be excellently maintained against the compressive stress applied to the shaft when the rotor member is fixed by a tight fit. Also a through hole is provided in the bottom portion to interconnect the space inside the rotary shaft with the space outside so that various particles generated in the rotary shaft can be easily discharged to the outside and therefore, the cleanliness of the rotary shaft can be easily and excellently obtained. Thus, with a simple and inexpensive configuration, the cylindrical hollow rotary shaft can be excellently supported and the environment of the motor use can be clean, improving the reliability of the motor.

The present invention provides a motor in accordance with the invention wherein the rotary shaft is supported by a hydrodynamic bearing that uses a dynamic pressure of a lubricant fluid so that the bearing property of a dynamic pressure motor using a hydrodynamic bearing member in particular can be well maintained. Therefore, the above-mentioned effects can be obtained with a dynamic pressure motor.

Further, the present invention provides a motor in accordance with the invention wherein a fixing mechanism used for mounting an appropriate rotary body to the rotary shaft is fixed to a through hole which is formed in the bottom portion of the rotary shaft. Consequently the rotary member can be easily and securely mounted using the through hole, improving the productivity of the motor in addition to the above mentioned effects.

Furthermore, the present invention provides a motor in accordance with the invention wherein the cylindrical hollow rotary shaft having the bottom portion is formed by drawing in order to efficiently manufacture the rotary shaft. In addition to the above-mentioned effects, the productivity of the motor can be further increased.

While the foregoing description and drawings represent the present invention, it will be obvious to those skilled in the art that various changes may be made therein without departing from the true spirit and scope of the present invention.

What is claimed is:

1. A motor comprising:
a cylindrical hollow rotary shaft;
a rotor member being fitted over an outer circumference of an axial end of said rotary shaft fixed by a tight fit; and
a bottom portion being integrally provided to said axial end portion of said rotary shaft, to which said rotor member is fixed, to close an opening at said end portion, said bottom portion having a through hole to interconnect a space inside said rotary shaft with a space outside.

2. The motor as set forth in claim 1 wherein said rotary shaft is supported by a hydrodynamic bearing member that uses a dynamic pressure of a lubricant fluid.

3. The motor as set forth in claim 1 wherein a fixing mechanism is fixed to said through hole to mount an appropriate rotary body onto said rotary shaft.

4. The motor as set forth in claim 1 wherein said cylindrical hollow rotary shaft having said bottom portion is formed by drawing.
